(19) United States
(12) Patent Application Publication
(10) Pub. No.: US 2025/0132388 A1
(43) Pub. Date: Apr. 24, 2025

(54) ELECTROLYTE FOR LITHIUM SECONDARY BATTERY, AND LITHIUM SECONDARY BATTERY COMPRISING SAME

(71) Applicant: Samsung SDI Co., Ltd., Yongin-si, Gyeonggi-do (KR)

(72) Inventors: Taejin Lee, Yongin-si (KR); Dahyun KIM, Yongin-si (KR); Minseo Kim, Yongin-si (KR); Myungheui Woo, Yongin-si (KR); Sanghoon Kim, Yongin-si (KR); Sanghyung Kim, Yongin-si (KR); Hyejin Park, Yongin-si (KR); Bokyung Ryu, Yongin-si (KR)

(21) Appl. No.: 18/689,829

(22) PCT Filed: Sep. 6, 2022
(86) PCT No.: PCT/KR2022/013325

§ 371 Date: Mar. 6, 2024

(30) Foreign Application Priority Data
Sep. 7, 2021 (KR) 10-2021-0119101

(51) Int. Cl. H01M 10/0567; H01M 4/525; H01M 10/0525

(52) U.S. Cl. CPC H01M 10/0567; H01M 4/525; H01M 10/0525; H01M 2300/0025

(57) ABSTRACT

An electrolyte for a lithium secondary battery and a lithium secondary battery are disclosed. The electrolyte for a lithium secondary battery includes: a lithium salt; an organic solvent; and an additive, wherein the additive includes a compound represented by Formula 1.

### TECHNICAL FIELD

The present disclosure relates to an electrolyte for a lithium secondary battery and a lithium secondary battery including the same.

### BACKGROUND ART

A lithium secondary battery is used as a driving power source for a portable electronic device such as a video camera, a mobile phone, a laptop, or the like. A rechargeable lithium secondary battery has high energy density per unit weight as compared with a lead-acid battery, a nickel-cadmium battery, a nickel-hydrogen battery, a nickel-zinc battery, and the like in the art, and can be charged at a high speed.

Since a lithium secondary battery operates at a high driving voltage, an aqueous electrolyte having high reactivity with lithium cannot be used. In this regard, an organic electrolyte is generally used as an electrolyte for a lithium secondary battery. An organic electrolyte is prepared by dissolving a lithium salt in an organic solvent. As an organic solvent, a material stable at a high voltage and having high ionic conductivity and dielectric permittivity and low viscosity is preferable.

However, when an organic electrolyte including a lithium salt is used as an electrolyte for a lithium secondary battery, due to a side reaction between an anode/cathode and an electrolyte, lifespan characteristics and long-term durability, high-temperature stability, and the like of a lithium secondary battery may be degraded.

In particular, when a lithium secondary battery is stored at or exposed to a high temperature, there is a risk of battery explosion due to increased gas release. To improve this, a method of reducing gas generation by adding an additional material to an electrolyte is used. However, materials capable of reducing gas generation at a high temperature mostly exhibit trade-off characteristics with high initial resistance. Therefore, there is a need to develop an electrolyte additive that does not additionally cause a significant increase in initial resistance while maintaining an effect of reducing gas generation at a high temperature.

### DISCLOSURE

### Technical Problem

A lithium secondary battery is used as a driving power source for a portable electronic device, such as a video camera, a mobile phone, a laptop, and the like. A rechargeable lithium secondary battery has high energy density per unit weight, and can be charged at high speed, as compared with a lead-acid battery, a nickel-cadmium battery, a nickel-hydrogen battery, a nickel-zinc battery, and the like in the art.

Since a lithium secondary battery operates at a high driving voltage, an aqueous electrolyte having high reactivity with lithium cannot be used. In this regard, as an electrolyte for a lithium secondary battery, an organic electrolyte is generally used. The organic electrolyte is prepared by dissolving a lithium salt in an organic solvent. As the organic solvent, a material stable at a high voltage and having high ionic conductivity and dielectric permittivity and low viscosity is preferable.

However, when an organic electrolyte including a lithium salt is used as an electrolyte for a lithium secondary battery, due to side reactions between an anode/cathode and the electrolyte, lifespan characteristics and long-term durability, high-temperature stability, and the like of the lithium secondary battery may be degraded.

In particular, when the lithium secondary battery is stored at or exposed to a high temperature, there is a risk of battery explosion due to an increased amount of gas released. To improve this, a method of reducing an amount of gas generation by adding an additional material to the electrolyte is considered. However, materials capable of reducing gas generation at a high temperature mostly exhibit trade-off characteristics with high initial resistance. Therefore, there is a need to develop an electrolytic additive that does not additionally cause a significant increase in initial resistance while maintaining an effect of reducing gas generation at a high temperature.

### Technical Solution

According to an aspect, provided is an electrolyte for a lithium secondary battery including:
a lithium salt; an organic solvent; and an additive, wherein
the additive includes a compound represented by Formula 1:

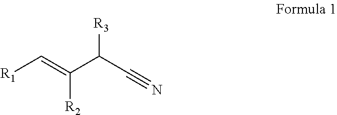

wherein, in Formula 1,
R₁ is a substituted or unsubstituted C₁-C₂₀ alkyl group, and
R₂ and R₃ are each independently selected from hydrogen, deuterium, a fluoro group (—F), a chloro group (—Cl), a bromo group (—Br), an iodo group (—I), a hydroxyl group, a cyano group, a nitro group, an amino group, an amidino group, a hydrazine group, a hydrazone group, a carboxylic acid or a salt thereof, a sulfonic acid or a salt thereof, a phosphoric acid or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B (Q₆)(Q₇), wherein Q₁ to Q₇ are each independently selected from hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, and a monovalent non-aromatic condensed heteropolycyclic group.

According to another aspect, provided is a lithium secondary battery including:
a cathode;
an anode; and
the electrolyte disposed between the cathode and the anode.

### Advantageous Effects

A lithium secondary battery including an electrolyte for a lithium secondary battery according to an embodiment may reduce an amount of gas generation even when exposed to a high temperature, and lower initial capacity.

### DESCRIPTION OF DRAWINGS

FIG. 1 is a schematic view of a lithium secondary battery according to an embodiment.

FIG. 2 is a graph obtained by evaluation of high-temperature storage characteristics of lithium secondary batteries prepared according to Examples 1 and 2 and Comparative Examples 1 to 8.

FIG. 3 is a graph obtained by evaluation of high-temperature storage characteristics of lithium secondary batteries prepared according to Examples 3 and 4 and Comparative Examples 9 to 16.

FIG. 4 is a graph showing a comparison of gas amounts generated during high-temperature storage of lithium secondary batteries using Ni-based cathodes according to Examples 5 and 6 and Comparative Example 17 and a comparison of gas amounts generated during high-temperature storage of lithium secondary batteries using Co-based cathodes according to Examples 7 and 8 and Comparative Example 18.

### BEST MODE

Hereinafter, an electrolyte for a lithium secondary battery according to embodiments and a lithium secondary battery including the same will be described in more detail.

Materials capable of reducing gas generation at a high temperature in the art mostly exhibit trade-off characteristics with high initial resistance. The same is applied for electrolytic additives of cyanide group (—CN) ligand types or hybrid types of double-bonded with a —CN ligand. In this regard, the inventors of the present invention have achieved the present invention by applying a compound represented by Formula 1 having a novel structure in which initial resistance does not additionally greatly increase while maintaining an effect of gas generation reduction exhibited in the existing structures.

The electrolyte for a lithium secondary battery according to an embodiment includes:
a lithium salt; an organic solvent; and an additive,
wherein the additive includes a compound represented by Formula 1:

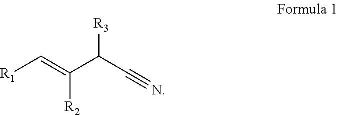

In Formula 1,
R₁ may be a substituted or unsubstituted C₁-C₂₀ alkyl group, and
R₂ and R₃ may each independently be selected from hydrogen, deuterium, a fluoro group (—F), a chloro group (—Cl), a bromo group (—Br), an iodo group (—I), a hydroxyl group, a cyano group, a nitro group, an amino group, an amidino group, a hydrazine group, a hydrazone group, a carboxylic acid or a salt thereof, a sulfonic acid or a salt thereof, a phosphoric acid or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B (Q₆)(Q₇), wherein Q₁ to Q₇ may each independently be selected from hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, and a monovalent non-aromatic condensed heteropolycyclic group.

The compound represented by Formula 1 has a structure in which both a cyanide group (—CN) ligand and a double bond are present, but are not hybridized. Furthermore, an alkyl group is introduced at the end of the double bond, so that effects of not only reducing the gas generation at a high temperature, but also not significantly increasing the initial resistance can be exhibited. The compound represented by Formula 1 may exhibit a greater effect of gas reduction improvement than a simple cyanide group ligand type additive, a hybrid type additive double-bonded with a cyanide group ligand, or a case where an alkyl group is not introduced at the end of the double bond.

Therefore, when the compound is used as an electrolyte additive for a lithium secondary battery, the lifespan characteristics can be improved by the effects of reducing the gas generation and improving the initial resistance during high-temperature storage in a lithium secondary battery.

In an embodiment, in Formula 1, R¹ may be a substituted or unsubstituted C₁-C₂₀ alkyl group, and R² and R³ may each independently be hydrogen or a substituted or unsubstituted C₁-C₂₀ alkyl group.

In an embodiment, in Formula 1, R¹ may be an unsubstituted linear or branched C₁-C₂₀ alkyl group, and R² and R³ may each independently be hydrogen.

In Formula 1, R₁ may be, for example, a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an n-pentadecyl group, an n-hexadecyl group, an n-heptadecyl group, an n-octadecyl group, an n-nonadecyl group, an n-eicosanyl group, an iso-propyl group, a sec-butyl group, an iso-butyl group, a tert-butyl group, a 1-methylbutyl group, a 1-ethylpropyl group, a 2-methylbutyl group, an iso-pentyl group, a neo-pentyl group, a 1,2-dimethylpropyl group, a 1,1-dimethylpropyl group, a tert-pentyl group, a 1,3-dimethylbutyl group, a 3,3-dimethylbutyl group, a 2-ethylbutyl group, a 2-ethyl-2-methylpropyl group, a linear or branched heptyl group, a 1-methylheptyl group, a 2-ethylhexyl group, a 1,5-dimethylhexyl group, a tert-octyl group, a branched nonyl group, a branched decyl group, a branched undecyl group, a branched dodecyl group, a branched tridecyl group, a branched tetradecyl group, a branched pentadecyl group, a branched hexadecyl group, a branched heptadecyl group, a branched octadecyl group, a linear or branched nonadecyl group, or a linear or branched eicosanyl group.

Among these groups, a methyl group, an ethyl group, an n-propyl group, an n-butyl group, an n-pentyl group, an n-hexyl group, an n-heptyl group, an n-octyl group, an n-nonyl group, an n-decyl group, an n-undecyl group, an n-dodecyl group, an n-tridecyl group, an n-tetradecyl group, an iso-propyl group, a sec-butyl group, an iso-butyl group, a tert-butyl group, a 1-methylbutyl group, a 1-ethylpropyl group, a 2-methylbutyl group, an iso-pentyl group, a neo-pentyl group, a 1,2-dimethylpropyl group, a 1,1-dimethylpropyl group, a tert-pentyl group, a 1,3-dimethylbutyl group, a 3,3-dimethylbutyl group, a 2-ethylbutyl group, a 2-ethyl-2-methylpropyl group, a linear or branched heptyl group, a 1-methylheptyl group, a 2-ethylhexyl group, a 1,5-dimethylhexyl group, a tert-octyl group, a branched nonyl group, or a branched decyl group may be preferable.

Among these groups, a methyl group, an ethyl group, an n-propyl group, an n-butyl group, an n-pentyl group, an n-hexyl group, an n-heptyl group, an n-octyl group, an n-nonyl group, an n-decyl group, an iso-propyl group, a sec-butyl group, an iso-butyl group, a tert-butyl group, a 1-methylbutyl group, a 1-ethylpropyl group, a 2-methylbutyl group, an iso-pentyl group, a neo-pentyl group, a 1,2-dimethylpropyl group, a 1,1-dimethylpropyl group, a tert-pentyl group, a 1,3-dimethylbutyl group, a 3,3-dimethylbutyl group, a 2-ethylbutyl group, or a 2-ethyl-2-methylpropyl group may be more preferable.

In an embodiment, the compound may be represented by Formula 2:

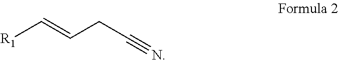

In Formula 2,

R¹ may be a substituted or unsubstituted C₁-C₂₀ alkyl group.

In Formula 2, R₁ may be, for example, selected from a methyl group, an ethyl group, a propyl group, an iso-propyl group, a butyl group, an iso-butyl group, a sec-butyl group, a tert-butyl group, a pentyl group, an iso-pentyl group, and a neo-pentyl group.

For example, the additive may include at least one of compounds represented by Formulae 3 to 6:

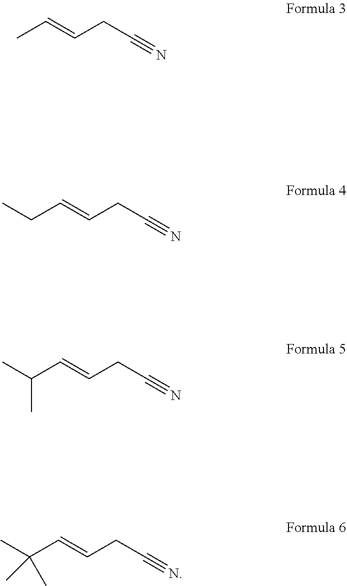

As the electrolyte for a lithium secondary battery includes the aforementioned compound as the additive, the gas generation may be suppressed when a lithium secondary battery including the electrolyte is exposed at a high temperature, resulting in effects of lowering initial resistance as well as improving high-temperature stability.

Furthermore, the electrolyte for a lithium secondary battery has an excellent effect in the resistance suppression at a high temperature of a lithium secondary battery including a lithium transition metal oxide with a high amount of nickel as a cathode active material, thereby providing a lithium secondary battery with long lifespan and improved high-temperature stability.

The term ‘substitution’ as used in the present specification refers that, unless otherwise defined herein, a hydrogen atom in a compound is substituent with a substituent selected from a halogen atom (e.g., F, Br, Cl, or I), a hydroxy group, an alkoxy group, a nitro group, a cyano group, an amino group, an azido group, an amidino group, a hydrazino group, a hydrazono group, a carbonyl group, a carbamyl group, a thiol group, an ester group, a carboxyl group or a salt thereof, a sulfonic acid group or a salt thereof, a phosphoric acid group or a salt thereof, a C1-C20 alkyl group, a C2-C20 alkenyl group, a C2-C20 alkynyl group, a C6-C30 aryl group, a C7-C30 arylalkyl group, a C1-C4 alkoxy group, a C1-C20 heteroalkyl group, a C3-C20 heteroarylalkyl group, a C3-C30 cycloalkyl group, a C3-C15 cycloalkenyl group, a C6-C15 cycloalkynyl group, a C2-C20 heterocycloalkyl group, and a combination thereof.

An amount of the compound represented by Formula 1 may be in a range of about 0.001 parts by weight to about 20 parts by weight based on 100 parts by weight of an electrolyte solution consisting of the lithium salt and the organic solvent. An upper limit of the amount of compound may be, based on 100 parts by weight of the electrolyte solution consisting of the lithium salt and the organic solvent, 20 parts by weight, for example, 15 parts by weight, 10 parts by weight, 5 parts by weight, 3 parts by weight, or 1 parts by weight. A lower limit of the amount of compound may be, based on 100 parts by weight of an electrolyte solution consisting of the lithium salt and the organic solvent, 0.001 parts by weight, for example, 0.01 parts by weight, 0.05 parts by weight, 0.07 parts by weight, 0.1 parts by weight, 0.2 parts by weight, 0.3 parts by weight, 0.4 parts by weight, or 0.5 parts by weight. Within the ranges above, a lithium secondary battery may improve the characteristics in terms of high-temperature storage and low-temperature discharge capacity, but embodiments are not limited thereto. In consideration of use of materials, such as a combination with other additives, the cathode active material, the anode active material, and the like, the amount of the compound can be adjusted within a general range.

In an embodiment, the electrolyte may further include other additives, and the other additives may include at least one of vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexanetricyanide (HTCN), propanesultone (PST), propanesultone (PS), lithium tetrafluoroborate (LiBF₄), lithium difluorophosphate (LiPO₂F₂), and 2-fluoro biphenyl (2-FBP).

An amount of the other additives may be, based on 100 parts by weight of an electrolyte solution consisting of the lithium salt and the organic solvent, in a range of 0.2 parts by weight to 20 parts by weight, for example, 0.2 parts by weight to 15 parts by weight, and for example, 0.2 parts by weight to 10 parts by weight. Within the ranges above, an increase in film resistance may be minimized by the other additives, thereby contributing to improving the battery performance.

In an embodiment, the lithium salt may include at least one selected from the group consisting of LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (2≤x≤20 and 2≤y≤20), LiCl, LiI, lithium bis(fluorosulfonyl)imide (LiFSI), lithium bis(oxalato) borate (LiBOB), LiPO₂F₂, and compounds represented by Formulae 7 to 10, but embodiments are not limited thereto. Any material available as the lithium salt in the art may be used.

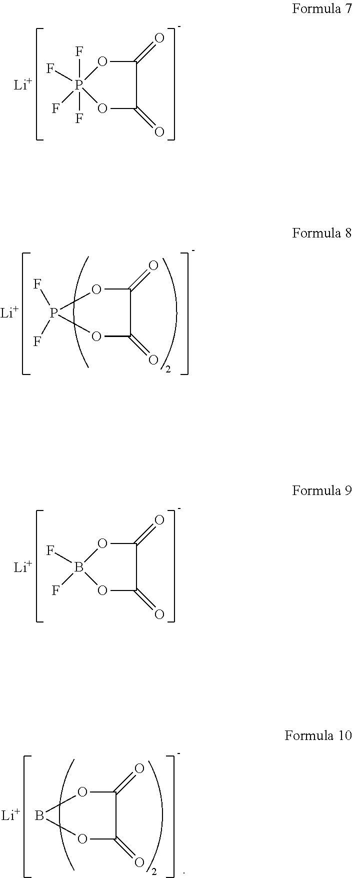

A concentration of the lithium salt in the electrolyte may be in a range of 0.01 to 5.0 M, for example, 0.05 to 5.0 M, 0.1 to 5.0 M, or 0.1 to 2.0 M. When the concentration of the lithium salt is within the ranges above, further improved characteristics of a lithium secondary battery may be obtained.

The organic solvent may include at least one selected from a carbonate-based solvent, an ester-based solvent, an ether-based solvent, and a ketone-based solvent.

Examples of the carbonate-based solvent are ethyl methyl carbonate (EMC), methyl propyl carbonate (MPC), ethyl propyl carbonate (EPC), dimethyl carbonate (DMC), diethyl carbonate (DEC), dipropyl carbonate (DPC), propylene carbonate (PC), ethylene carbonate (EC), fluoro ethylene carbonate (FEC), vinylene carbonate (VC), vinyl ethylene carbonate (VEC), butylene carbonate (BC). Examples of the ester-based solvent are methyl propionate, ethyl propionate, propyl propionate, ethyl butylate, methyl acetate, ethyl acetate, n-propyl acetate, dimethyl acetate, gamma-butyrolactone, decanolide, gamma-valerolactone, mevalonolactone, caprolactone, and the like. Examples of the ether-based solvent are dibutyl ether, tetraglyme, diglyme, dimethoxyethane, 2-methyl tetrahydrofuran, tetrahydrofuran, and the like. Examples of the ketone-based solvent are cyclohexanone and the like. Examples of the nitrile-based solvent are AN, SN, adiponitrile, and the like. Examples of the other solvents are dimethyl sulfoxide, dimethylformamide, dimethylacetamide, tetrahydrofuran, and the like, but are not essentially limited thereto. Any material available as the organic solvent in the art may be used. For example, the organic solvent may be a mixed solvent containing 50 vol % to 95 vol % of chain-type carbonate and 5 vol % to 50 vol % of ring-type carbonate, for example a mixed solvent containing 70 vol % to 95 vol % of chain-type carbonate and 5 vol % to 30 vol % of ring-type carbonate. For example, the organic solvent may be a mixed solvent of three or more organic solvents.

In an embodiment, the organic solvent may include at least one selected from the group consisting of EMC, MPC, EPC, DMC, DEC, DPC, PC, EC, FEC, VC, VEC, CB, ethyl propionate, propyl propionate, ethyl butylate, dimethyl sulfoxide, dimethylformamide, dimethylacetamide, gamma-valerolactone, gamma-butyrolactone, and tetrahydrofuran, but is not limited thereto. Any material available as the organic solvent in the art may be used.

The electrolyte may be in a liquid state or a gel state. The electrolyte may be prepared by adding the lithium salt and the aforementioned additives to the organic solvent.

A lithium secondary battery according to an embodiment includes: a cathode including a cathode active material; an anode including an anode active material; and the electrolyte disposed between the cathode and the anode.

By including the aforementioned compound, the lithium secondary battery may improve high-temperature stability and initial resistance characteristics.

As the cathode active material, any suitable lithium-containing metal oxide generally used in the art may be used without limitation. For example, at least one composite oxide including lithium and a metal selected from cobalt, manganese, nickel, and a combination thereof may be used, and a specific example thereof is a compound represented by one of the following formulae: LiₐA_{1-b}B¹_{b}D¹₂ (where 0.90≤a≤1.8 and 0≤b≤0.5); LiₐE_{1-b}B¹_{b}O_{2-c}D_{1c} (where 0.90≤a≤1.8, 0≤b≤0.5, and 0≤c≤0.05); LiE_{2-b}B¹_{b}O_{4-c}D¹_{c} (where 0≤b≤0.5 and 0≤c≤0.05); LiₐNi_{1-b-c}Co_{b}B¹_{c}D¹_{α} (where 0.90≤a≤1.8, 0≤b≤0.5, 0≤c≤0.05, and 0<α≤2); LiₐNi_{1-b-c}Co_{b}B¹_{c}O₂₋ₐF¹_{α} (where 0.90≤a≤1.8, 0≤b≤0.5, 0≤c≤0.05, and 0<α≤2); LiₐNi_{1-b-c}Co_{b}B¹_{c}O₂₋ₐF¹₂ (where 0.90≤a≤1.8, 0≤b≤0.5, 0≤c≤0.05, and 0<α≤2); LiₐNi_{1-b-c}Mn_{b}B¹_{c}D_{α} (where 0.90≤a≤1.8, 0≤b≤0.5, 0≤c≤0.05, and 0<α≤2); LiₐNi_{1-b-c}Mn_{b}B¹_{c}O_{2-α}F¹_{α} (where 0.90≤a≤1.8, 0≤b≤0.5, 0≤c≤0.05, and 0<α<2); LiₐNi_{1-b-c}Mn_{b}B¹_{c}O_{2-α}F¹₂ (where 0.90≤a≤1.8, 0≤b≤0.5, 0≤c≤0.05, and 0<α≤2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}MnₐGeO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiIO₂; LiNiVO₄; Li_{(3-f)}Fe₂(PO₄)₃ (where 0≤f≤2); Li_{(3-f)}Fe₂(PO₄)₃ (where 0≤f≤2); and LifePO₄.

In the formulae above, A may be Ni, Co, Mn, or a combination thereof; B¹ may be Al, Ni, Co, Mn, Cr, Fe, Mg, Sr, V, a rare earth element, or a combination thereof; D¹ may be O, F, S, P, or a combination thereof; E may be Co, Mn, or a combination thereof; F¹ may be F, S, P, or a combination thereof; G may be Al, Cr. Mn, Fe, Mg, La, Ce, Sr. V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof.

For example, the cathode active material may be LiCoO₂, LiMnₓO₂ₓ (where x is 1 or 2), LiN₁₋ₓMnₓO₂ₓ (where 0<x<1), LiN_{1-x-y}CoₓMn_{y}O₂ (where 0≤x≤0.5, and 0≤y≤0.5), LiFePO₄, or the like.

As the cathode active material, a material having a coating layer on a surface of the compound may be also used, and in one or more embodiments, a mixture of the compound and a compound having a coating layer may be also used. Here, the coating layer may include a compound of a coating element, such as an oxide of a coating element, a hydroxide of a coating element, an oxyhydroxide of a coating element, an oxycarbonate of a coating element, or a hydroxycarbonate of a coating element. The compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. When forming the coating layer, any coating method may be used as long as the compound can be coated in a method (e.g., spray coating, dipping method, etc.) that does not adversely affect the physical properties of the cathode active material by using the aforementioned elements. Such a coating method is well understood by those skilled in the art, and thus a detailed description thereof will be omitted.

In an embodiment, the cathode active material may include a lithium transition metal oxide including nickel and other transition metals. In the lithium transition metal oxide including nickel and other transition metals, an amount of the nickel may be, based on the total number of moles of the transition metal, greater than or equal to 60 mol %, for example, greater than or equal to 75 mol %, greater than or equal to 80 mol %, greater than or equal to 85 mol %, and greater than or equal to 90 mol %, and less than 100 mol %.

For example, the lithium transition metal oxide may be a compound represented by Formula 11:

LiₐNiₓCo_{y}M_{z}O_{2-b}A_{b} Formula 11
wherein, in Formula 11, 1.0≤a≤1.2, 0≤b≤0.2, 0.6≤x<1, 0<y≤0.3, 0<z≤0.3, x+y+z=1, M may be at least one selected from the group consisting of Mn, V, Mg, Ga, Si, W, Mo, Fe, Cr, Cu, Zn, Ti, Al, and B, and A may be F, S, Cl, Br, or a combination thereof. For example, 0.7≤x<1, 0<y≤0.3, and 0<z≤0.3; 0.8≤x<1, 0<y≤0.3, and 0<z≤0.3; 0.8≤x<1, 0<y≤0.2, and 0<z≤0.2; 0.83≤x<0.97, 0<y≤0.15, and 0<z≤0.15; or 0.85≤x<0.95, 0<y≤0.1, and 0<z≤0.1.

For example, the lithium transition metal oxide may be at least one of compounds represented by Formulae 12 and 13:

LiNiₓCo_{y}Mn_{z}O₂ Formula 12
wherein, in Formula 12, 0.6≤x≤0.95, 0<y≤0.2, and 0<z≤0.1. For example, 0.7≤x≤0.95, 0<y≤0.3, and 0<z≤0.3.

LiNiₓCo_{y}Al₂O₂ Formula 13
wherein, in Formula 13, 0.6≤x≤0.95, 0<y≤0.2, and 0<z≤0.1. For example, 0.7≤x≤0.95, 0<y≤0.3, and 0<z≤0.3. For example, 0.8≤x≤0.95, 0<y≤0.3, and 0<z≤0.3. For example, 0.82≤x≤0.95, 0<y≤0.15, and 0<z≤0.15. For example, 0.85≤x≤0.95, 0<y≤0.1, and 0<z≤0.1.

For example, the lithium transition metal oxide may be LiNi_{0.6}Co_{0.2}Mn_{0.2}O₂, LiNi_{0.88}Co_{0.08}Mn_{0.04}O₂, LiNi_{0.8}Co_{0.15}Mn_{0.05}O₂, LiNi_{0.8}Co_{0.1}Mn_{0.1}O₂, LiNi_{0.88}Co_{0.1}Mn_{0.02}O₂, LiNi_{0.8}Co_{0.15}Al_{0.05}O₂, LiNi_{0.8}Co_{0.1}Mn_{0.2}O₂, LiNi_{0.88}Co_{0.1}Al_{0.02}O₂, or LiNi_{0.915}Co_{0.07}Al_{0.015}O₂.

In one or more embodiments, the cathode active material may include at least one active material selected from the group consisting of Li—Ni—Co—Al (NCA), Li—Ni—Co—Mn (NCM), lithium cobalt oxide (LiCoO₂), lithium manganese oxide (LiMnO₂), lithium nickel oxide (LiNiO₂), and lithium iron phosphate oxide (LiFePO₄).

The anode active material may include at least one selected from a silicon-based compound, a carbon-based material, a composite of silicon-based compound and carbon-based compound, and silicon oxide (SiOₓ, 0<x<2). The silicon-based compound may include a silicon particle, a silicon alloy particle, and the like.

A size of the silicon-based compound may be less than 200 nm, for example, in a range of 10 nm to 150 nm. The term “size” may refer to an average particle diameter when the silicon-based compound is spherical, and may refer to an average major axis length when the silicon particle is non-spherical.

When the size of the silicon-based compound is within the ranges above, the lifespan characteristics are excellent, and thus use of the electrolyte according to an embodiment may further improve the lifespan of the lithium secondary battery.

The carbon-based material may be crystalline carbon, amorphous carbon, or a mixture thereof. The crystalline carbon may be graphite, such as natural graphite or artificial graphite, which is amorphous or in a laminaris, flake, spherical, or fiber form. The amorphous carbon may include soft carbon (low-temperature calcined carbon), hard carbon (hard carbon), mesophase pitch carbide, calcined coke, and the like.

The composite of silicon-based compound and carbon-based compound may be a composite having a structure in which silicon nanoparticles are arranged on a carbon-based compound, a composite in which silicon particles are included on a surface and inside in a carbon-based compound, or a composite in which silicon particles are coated with a carbon-based compound to be included inside a carbon-based compound. The carbon-based compound of the composite of silicon-based compound and carbon-based compound may be graphite, graphene, graphene oxide, or a combination thereof.

The composite of silicon-based compound and carbon-based compound may include an active material obtained by carbon coating after dispersing silicon nanoparticles having an average particle of about 200 nm on particles of the carbon-based compound, an active material in which silicon (Si) particles are present on and inside graphite, or the like. An average particle diameter of secondary particles of the composite of silicon-based compound and carbon-based compound may be in a range of 5 μm to 20 μm. An average particle diameter of the silicon nanoparticles may be greater than or equal to 5 nm, for example, greater than or equal to 10 nm, for example, greater than or equal to 20 nm, for example, greater than or equal to 50 nm, or for example, greater than or equal to 70 nm. The average particle diameter of the silicon nanoparticles may be less than or equal to 200 nm, less than or equal to 150 nm, less than or equal to 100 nm, less than or equal to 50 nm, less than or equal to 20 nm, or less than or equal to 10 nm. For example, the average particle diameter of the silicon nanoparticles may be in a range of 100 nm to 150 nm.

The average particle diameter of the secondary particles of the composite of silicon-based compound and carbon-based compound may be in a range of 5 μm to 18 μm, for example 7 μm to 15 μm, or for example 10 μm to 13 μm.

As another example of the composite of silicon-based compound and carbon-based compound, the porous silicon composite cluster disclosed in KR 10-2018-0031585 and the porous silicon composite cluster structure disclosed in KR 10-2018-0056395 may be used. KR 10-2018-0031586 and KR 10-2018-0056395 are incorporated herein by references.

The silicon-carbon-based compound composite according to another embodiment may be a porous silicon composite cluster structure including: a porous silicon composite cluster including secondary particles of a porous silicon composite and a second carbon flake on at least one surface of the secondary particles of the porous silicon composite cluster; and a carbon-based coating film arranged on the porous silicon composite cluster and including amorphous carbon. The secondary particle of the porous silicon composite may include an aggregate of two or more primary particles of the silicon composite, and the primary particle of the silicon composite may include silicon, silicon oxide (SiOₓ) (0<X<2) arranged on the silicon, and first graphene arranged on the silicon oxide.

The silicon-carbon-based compound composite according to another embodiment may be a porous silicon composite cluster structure including: a porous silicon composite cluster including secondary particles of a porous silicon composite and a second carbon flake on at least one surface of the secondary particles of the porous silicon composite cluster; and a carbon-based coating film arranged on the porous silicon composite cluster and including amorphous carbon. The secondary particle of the porous silicon composite may include an aggregate of two or more primary particles of the silicon composite, and the primary particle of the silicon composite may include silicon, silicon oxide (SiOₓ) (0<x<2) arranged on the silicon, and a first flake arranged on at least one surface of the silicon oxide, wherein the silicon oxide is present in the state of a film, a matrix, or a combination thereof.

The first carbon flake and the second carbon flake may each be present in the state of a film, a particle, a matrix, or a combination thereof. In addition, the first carbon flake and the second carbon flake may each be graphene, graphite, carbon fiber, graphene oxide, or the like.

The composite of silicon-based compound and carbon-based compound may be a composite having a structure in which silicon nanoparticles are arranged on a carbon-based compound, a composite in which silicon particles are included on a surface and inside carbon-based compound, or a composite in which silicon particles are coated with a carbon-based compound to be included inside a carbon-based compound. The carbon-based compound of the composite of silicon-based compound and carbon-based compound may be graphite, graphene, graphene oxide, or a combination thereof.

The shape of the lithium secondary battery is not particularly limited, and examples of the lithium secondary battery are a lithium ion battery, a lithium ion polymer battery, a lithium sulfur battery, and the like.

The lithium secondary battery may be prepared by the following method.

First, a cathode may be prepared.

For example, a cathode active material composition in which a cathode active material, a conductive material, a binder, and a solvent are mixed may be prepared. A cathode plate may be prepared by directly coating a metal current collector with the cathode active material composition. Alternatively, the cathode plate may be prepared by casting the cathode active material composition on a separate support, and then laminating a film separated from the support on a metal current collector. The cathode is not limited to the forms listed above, and may be in a form other than the aforementioned forms.

As the cathode active material, any material available as a lithium-containing metal oxide in the art may be used. For example, at least one composite oxide including lithium and a metal selected from Co, Mn, Ni, and a combination thereof may be used, and a specific example thereof is a compound represented by one of the following formulae: LiₐA_{1-b}B¹_{b}D¹₂ (where 0.90≤a≤1.8 and 0≤b≤0.5); LiₐE_{1-b}B¹_{b}O_{2-c}D_{1c} (where 0.90≤a≤1.8, 0≤b≤0.5, and 0≤c≤0.05); LiE_{2-b}B¹_{b}O_{4-c}D¹_{c} (where 0≤b≤0.5 and 0≤c≤0.05); LiₐNi_{1-b-c}Co_{b}B¹_{c}D¹ₐ (where 0.90≤a≤1.8, 0≤b≤0.5, 0≤c≤0.05, and 0<α≤2); LiₐNi_{1-b-c}Co_{b}B¹_{c}O₂₋ₐF¹ₐ (where 0.90≤a≤1.8, 0≤b≤0.5, 0≤c≤0.05, and 0<α≤2); LiₐNi_{1-b-c}Co_{b}B¹_{c}O_{2-α}F¹₂ (where 0.90≤a≤1.8, 0≤b≤0.5, 0≤c≤0.05, and 0≤α≤2); LiₐNi_{1-b-c}Mn_{b}B¹_{c}D_{α} (where 0.90≤a≤1.8, 0≤b≤0.5, 0≤c≤0.05, and 0<α≤2); LiₐNi_{1-b-c}Mn_{b}B¹_{c}O₂₋ₐF¹ₐ (where 0.90≤a≤1.8, 0≤b≤0.5, 0≤c≤0.05, and 0<α<2); LiₐNi_{1-b-c}Mn_{b}B¹_{c}O₂₋ₐF¹₂ (where 0.90≤a≤1.8, 0≤b≤0.5, 0≤c≤0.05, and 0<α<2); LiₐNi_{b}E_{c}GaO₂ (where 0.90≤a≤1.8, 0≤b≤0.9, 0≤c≤0.5, and 0.001≤d≤0.1); LiₐNi_{b}Co_{c}Mn_{d}GeO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); and LiFePO₄.

In the formulae above, A may be Ni, Co, Mn, or a combination thereof; B¹ may be Al, Ni, Co, Mn, Cr, Fe, Mg, Sr, V, a rare earth element, or a combination thereof; D¹ may be O, F, S, P, or a combination thereof; E may be Co, Mn, or a combination thereof; F¹ may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof.

For example, the cathode active material may be LiCoO₂, LiMnₓO₂ₓ (where x is 1 or 2), LiN₁₋ₓMnₓO₂ₓ (where 0<x<1), LiNi_{1-x-y}CoₓMn_{y}O₂ (where 0≤x≤0.5, and 0≤y≤0.5), LiFePO₄, or the like.

As the cathode active material, a material having a coating layer on a surface of the compound may be also used, and in one or more embodiments, a mixture of the compound and a compound having a coating layer may be also used. Here, the coating layer may include a coating element compound of an oxide of a coating element, a hydroxide, an oxyhydroxide of a coating element, an oxycarbonate of a coating element, or a hydroxycarbonate of a coating element. The coating element compound constituting the coating layer may be amorphous or crystalline. The coating element included in the coating layer may be Mg, Al, Co, K, Na, Ca, Si, Ti, V, Sn, Ge, Ga, B, As, Zr, or a mixture thereof. When forming the coating layer, any coating method may be used as long as the compound can be coated in a method (e.g., spray coating, dipping method, etc.) that does not adversely affect the physical properties of the cathode active material by using the aforementioned elements. Such a coating method is well understood by those skilled in the art, and thus a detailed description thereof will be omitted.

Examples of the conductive material are carbon black, graphite fine particle, and the like, but are not limited thereto. Any material available as the conductive material in the art may be used.

Examples of the binder are a vinylidene fluoride/hexafluoropropylene copolymer, polyvinylidene fluoride (PVDF), polyacrylonitrile, polymethyl methacrylate, polytetrafluoroethylene, a mixture thereof, or a styrene butadiene-rubber polymer, and the like, but are not limited thereto. Any material available as the binder in the art may be used.

Examples of the solvent are N-methyl pyrrolidone, acetone, water, and the like, but are not limited thereto. Any material available as the solvent in the art may be used.

The amounts of the cathode active material, the conductive material, the binder, and the solvent may be at levels suitable for use in a lithium battery. Depending on the use and configuration of the lithium battery, one or more of the conductive material, the binder, and the solvent may be omitted.

Next, an anode may be prepared.

For example, an anode active material composition in which an anode active material, a conductive material, a binder, and a solvent are mixed may be prepared. An anode plate may be prepared by directly coating a metal current collector with the anode active material composition. Alternatively, the anode plate may be prepared by casting the anode active material composition on a separate support, and then laminating a film separated from the support on a metal current collector.

As the anode active material, any material available as the anode active material in the art for a lithium battery may be used. For example, the anode active material may include at least one selected from a lithium metal, a metal alloyable with lithium, a transition metal oxide, a non-transition metal oxide, and a carbon-based material.

Examples of the metal alloyable with lithium are silicon (Si), tin (Sn), aluminum (Al), germanium (Ge), lead (Pb), bismuth (Bi), antimony (Sb), a Si—Y alloy (where Y is an alkali metal, an alkaline earth metal, a Group 13 element, a Group 14 element, a transition metal, a rare earth element, or a combination thereof, and Y is not Si), a Sn—Y alloy (where Y is an alkali metal, an alkaline earth-metal, a Group 13 element, a Group 14 element, a transition metal, a rare earth element, or a combination thereof, and Y is not Sn), and the like. The element Y may be, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

For example, the transition metal oxide may include a lithium titanium oxide, a vanadium oxide, a lithium vanadium oxide, and the like.

For example, the non-transition metal oxide may be SnO₂, SiOₓ (where 0<x<2), and the like.

The carbon-based material may be crystalline carbon, amorphous carbon, or a mixture thereof. The crystalline carbon may be graphite, such as natural graphite or artificial graphite, which is amorphous or in a laminaris, flake, spherical, or fiber form. The amorphous carbon may include soft carbon (low-temperature calcined carbon), hard carbon (hard carbon), mesophase pitch carbide, calcined coke, and the like.

In the anode active material composition, the same conductive material and binder as in the case of the cathode active material may be used.

The amounts of the anode active material, the conductive material, the binder, and the solvent may be at levels suitable for use in a lithium battery. Depending on the use and configuration of the lithium battery, one or more of the conductive material, the binder, and the solvent may be omitted.

Next, a separator to be disposed between the cathode and the anode may be prepared.

As the separator, any material available as the separator in the art for a lithium battery may be used. A separator having a low resistance to movement of ions in an electrolyte and excellent electrolyte wettability may be used. For example, the separator may be selected from glass fiber, polyester. Teflon, polyethylene, polypropylene, polytetrafluoroethylene (PTFE), and a combination thereof, and may be in any form of a non-woven fabric or a woven fabric. For example, a rollable separator including polyethylene, polypropylene, or the like may be used for a lithium ion battery, and a separator with excellent impregnation for an organic electrolyte solution may be used for a lithium ion polymer battery. For example, the separator may be prepared by the following method.

A separator composition may be prepared by mixing a polymer resin, a filler, and a solvent. Then, the separator composition may be directly coated on an electrode, and then dried to form a separator. Alternatively, the separator composition may be cast on a support, and then dried to form a separator film. The film may be then separated from the support and laminated on an electrode to form a separator.

The polymer used in the preparation of the separator is not particularly limited, and any material available as the binder for an electrode plate may be used. For example, a vinylidene fluoride/hexafluoropropylene copolymer, PVDF, polyacrylonitrile, polymethylmethacrylate, or a mixture thereof may be used.

In addition, the separator may include, although not limited thereto, for example, a polyethylene separator (PES), a polypropylene separator (PPS), a ceramic coated separator (CCS), a polymer coated separator (PCS), a multi-layer coated separator (MCS), a multi-functional separator (MFS), and the like, or a combination thereof.

Next, the aforementioned electrolyte solution may be prepared.

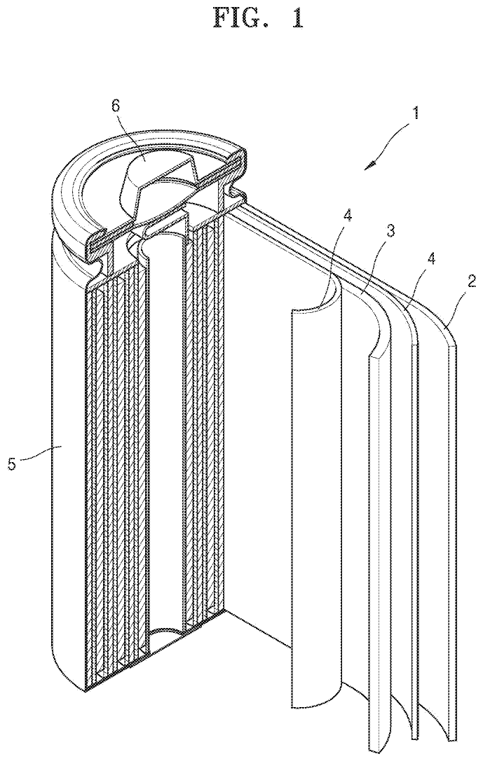

As shown in FIG. 1, a lithium battery 1 includes a cathode 3, an anode 2, and a separator 4. The cathode 3, the anode 2, and the separator 4 may be wound or folded to be accommodated in a battery case 5. Next, the battery case 5 may be filled with an organic electrolyte solution, and then sealed with a cap assembly 6, thereby completing the manufacture of the lithium battery 1. The battery case 5 may be a pouch type, a cylindrical shape, a prismatic shape, or a thin-film type. For example, the lithium battery 1 may be a large thin-film type battery. The lithium battery 1 may be a lithium ion battery.

In a cylindrical battery, an electrode assembly having a cylindrical shape in which a separator is wound between a cathode and an anode is formed. The cylindrical battery is inserted into a cylindrical can, which is then filled with an electrolyte solution. The cylindrical can may be formed of steel, steel alloy, nickel-plated steel, nickel-plated steel alloy, aluminum, aluminum alloy, or an equivalent material thereof, but the material is not limited thereto. In addition, in the cylindrical can, a beading part recessed inwardly may be formed at the bottom of a cap assembly around the cap assembly to prevent the cap assembly from escaping to the outside, and a crimping part bent inward at the top of the cap assembly may be formed.

In an embodiment, a plurality of battery structures, each of which a separator is disposed between the cathode and the anode, may be stacked to form a battery pack, and such a battery pack may be applicable in all devices requiring high capacity and high output. For example, the battery pack may be used in a laptop computer, a smart phone, an electronic vehicle, or the like.

The lithium secondary battery according to an embodiment may have, compared to a lithium secondary battery using a general nickel-rich lithium nickel composite oxide as a cathode active material, significantly decreased rate of increase in direct current internal resistance (DCIR), thereby exhibiting excellent battery characteristics.

An operating voltage of the lithium secondary battery including the cathode, the anode, and the electrolyte may have, for example, a lower limit in a range of 2.5 V to 2.8 V and an upper limit of 4.1 V or more, for example, in a range of 4.1 V to 4.45 V.

In addition, the lithium secondary battery may be applicable in, for example: a power tool that is power-driven by a universal motor; an electric automobile, such as an electric vehicle (EV), a hybrid electric vehicle (HEV), a plug-in hybrid electric vehicle (PHEV), or the like; an electric two-wheeled vehicle, such as an electric bicycle (E-bike) or an electric scooter (E-scooter); an electric golf cart; an electric power storage system, but embodiments are not limited thereto.

In the present specification, the term “alkyl group” refers to a branched or unbranched aliphatic hydrocarbon group. In an embodiment, the alkyl group may be in a substituted state or an unsubstituted state. Examples of the alkyl group are a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl group, and the like, but embodiments are not limited thereto. Each of these substituents may be selectively substituted. In one or more embodiments, the alkyl group may include 1 carbon atom to 6 carbon atoms. Examples of the C₁-C₆ alkyl group are a methyl group, an ethyl group, a propyl group, an isopropyl group, a butyl group, an isobutyl group, a sec-butyl group, a pentyl group, a 3-pentyl group, a hexyl group, and the like, but embodiments are not limited thereto.

At least one hydrogen atom of the alkyl group may be substituted with a halogen atom, a C₁-C₂₀ alkyl group substituted with halogen atom (e.g., CF₃, CHF₂, CH₂F, CCl₃, etc.), a C1-C20 alkoxy group, a C2-C20 alkoxyalkyl group, a hydroxy group, a nitro group, a cyano group, an amino group, an amidino group, a hydrazine group, a hydrazone group, a carboxyl group or a salt thereof, a sulfonyl group, a sulfamoyl group, a sulfonic acid group or a salt thereof, a phosphoric acid group or a salt thereof, or a C1-C20 alkyl group, a C2-C20 alkenyl group, a C2-C20 alkynyl group, a C1-C20 heteroalkyl group, a C6-C20 aryl group, a C7-C20 arylalkyl group, a C6-C20 heteroaryl group, a C7-C20 heteroarylalkyl group, a C6-C20 heteroaryloxy group, or a C6-C20 heteroaryloxyalkyl group.

In the present specification, the term “alkenyl group” refers to a C2-C20 hydrocarbon group including at least one carbon-carbon double bond, and examples thereof are an ethenyl group, a 1-prophenyl group, a 2-prophenyl group, a 2-methyl-1-prophenyl group, a 1-butenyl group, a 2-butenyl group, a cycloprophenyl group, a cyclopentenyl group, a cyclohexenyl group, a cyclopentenyl group, and the like. However, embodiments are not limited thereto. In one or more embodiments, the alkenyl group may be in a substituted state or an unsubstituted state. In one or more embodiments, the alkenyl group may include 2 carbon atoms to 40 carbon atoms.

In the present specification, the term “alkynyl group” refers to a C2-C20 hydrocarbon group including at least one carbon-carbon triple bond, and examples thereof are an ethynyl group, a 1-propynyl group, a 1-butynyl group, a 2-butynyl group, and the like. However, embodiments are not limited thereto. In one or more embodiments, the alkynyl group may be in a substituted state or an unsubstituted state. In one or more embodiments, the alkynyl group may include 2 carbon atoms to 40 carbon atoms.

In the present specification, a substituent is derived from an unsubstituted parent group, wherein at least one hydrogen atom is substituted with another atom or functional group. Unless otherwise indicated, in a case where a functional group is considered “substituted”, the functional group is meant to be substituted with at least one substituent independently selected from the group consisting of a C₁-C₂₀ alkyl group, a C₂-C₂₀ alkenyl group, a C₂-C₂₀ alkynyl group, a C₁-C₂₀ alkoxy group, a halogen, a cyano group, a hydroxy group, and a nitro group. When a functional group is described as “optionally substituted”, the functional group may be substituted with the aforementioned substituent.

The term “halogen” may include fluorine, bromine, chlorine, iodine, and the like.

The term “alkoxy” refers to “alkyl-O—”, wherein the alkyl is the same as defined above. Examples of the alkoxy group are a methoxy group, an ethoxy group, a 2-propoxy group, a butoxy group, a t-butoxy group, a pentyloxy group, a hexyloxy group, and the like. At least one hydrogen atom of the alkoxy group may be substituted with the same substituents as in the case of the aforementioned alkyl group.

The term “heteroaryl” refers to a monocyclic or bicyclic organic group including at least one hetero atom selected from N, O, P, and S and carbon atoms as the remaining ring atoms. The heteroaryl group may include, for example, 1 hetero atom to 5 hetero atoms and 5 ring members to 10 ring members. Here, S or N may be oxidized and then have several oxidation states.

Examples of the heteroaryl are thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, a 1,3,4-oxadiazolyl, 1,2,3-thiadiazolyl, 1,2,4-thiadiazolyl, 1,2,5-thiadiazolyl, 1,3,4-thiadiazolyl, isothiazole-3-yl, isothiazole-4-yl, isothiazole-5-yl, oxazole-2-yl, oxazole-4-yl, oxazole-5-yl, isooxazole-3-yl, isooxazole-4-yl, isooxazole-5-yl, 1,2,4-triazole-3-yl, 1,2,4-triazole-5-yl, 1,2,3-triazole-4-yl, 1,2,3-triazole-5-yl, tetrazolyl, pyrid-2-yl, pyrid-3-yl, 2-pyrazine-2-yl, pyrazine-4-yl, pyrazine-5-yl, 2-pyrimidine-2-yl, 4-pyrimidine-2-yl, 5-pyrimidine-2-yl, and the like.

The term “heteroaryl” refers to a heteroaromatic ring optionally fused to at least one aryl, cycloaliphatic, or heterocycle.

The term “carbon ring” refers to a non-aromatic monocyclic hydrocarbon group, a bicyclic hydrocarbon group, or a tricyclic hydrocarbon group, each being saturated or partially unsaturated.

Examples of the monocyclic hydrocarbon are cyclopentyl, cyclopentenyl, cyclohexyl, cyclohexenyl, and the like.

Examples the bicyclic hydrocarbon are bornyl, decahydronaphthyl, bicyclo[2.1.1]hexyl, bicyclo[2.2.1]heptyl, bicyclo[2.2.1]heptenyl, bicyclo[2.2.2]octyl, and the like.

Examples of the tricyclic hydrocarbon are adamantyl and the like.

At least one hydrogen atom of the carbon ring may be substituted with the same substituents as in the case of the aforementioned alkyl group.

### MODE FOR INVENTION

The present disclosure is in greater details through Examples and Comparative Examples below. However, the following embodiments are for illustrative purpose only and shall not be construed as limiting the scope of the disclosure.

### (Preparation of Lithium Secondary Battery)

### EXAMPLE 1

To a mixed solvent containing ethylene carbonate (EC), ethylmethyl carbonate (EMC), and dimethyl carbonate (DMC) at a volume ratio of 20:10:70, 1.5 M LiPF₆ was added, and based on 100 parts by weight of an electrolyte solution consisting of a lithium salt and an organic solvent, 5.0 parts by weight of FEC and 1.0 parts by weight of a compound represented by Formula 3 (3-penetenenitrile, Sigma aldrich) were added thereto, so as to prepare an electrolyte for a lithium secondary battery.

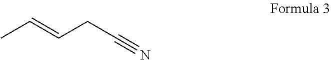

97 wt % of LiNi_{0.88}Co_{0.105}Al_{0.015}O₂ as a cathode active material, 0.5 wt % of artificial graphite powder, 0.8 wt % of carbon black, and 1.7 wt % of polyvinylidene fluoride (PVdF) as conductive materials were mixed and added to N-methyl-2-pyrrolidone. The resulting mixture was stirred for 4 hours by using a mechanical stirrer to prepare a cathode active material slurry. The slurry was uniformly applied on an aluminum current collector having a 12-μm thick aluminum current collector by using a coater, and then dried with hot air at 100° C. After the drying, a roll pressing was performed thereon to prepare a cathode.

As anode active materials, 87 wt % of artificial graphite, 10.5 wt % of a silicon composite, 1.5 wt % of SBR, and 1 wt % of CMC were mixed and dispersed in water, so as to prepare an anode active material slurry. The slurry was uniformly applied on a 10-μm thick copper current collector continuously by using a coater, and then dried with hot air at 100° C. Afterwards, a roll pressing was performed thereon to prepare an anode.

By using the prepared cathode and anode, a 14-μm thick polyethylene separator, and the electrolyte, a 4.2 V cylindrical-type lithium secondary battery was prepared.

### EXAMPLE 2

A lithium secondary battery was prepared in the same manner as in Example 1, except that 1.0 parts by weight of a compound represented by Formula 6 ((E)-5,5-dimethylhex-3-enenitrile, Aurora Building Blocks1) was added instead of the compound represented by Formula 3 (3-penetenenitrile, Sigma aldrich).

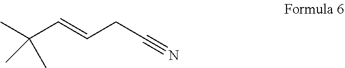

### COMPARATIVE EXAMPLE 1

A lithium secondary battery was prepared in the same manner as in Example 1, except that an electrolyte in which the compound used in Example 1 was not added was used.

### COMPARATIVE EXAMPLE 2

A lithium secondary battery was prepared in the same manner as in Example 1, except that succinonitrile represented by Formula 11 was added instead of the compound used in Example 1.

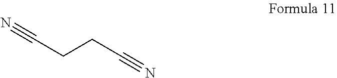

### COMPARATIVE EXAMPLE 3

A lithium secondary battery was prepared in the same manner as in Example 1, except that fumaronitrile represented by Formula 12 was added instead of the compound used in Example 1.

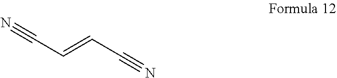

### COMPARATIVE EXAMPLE 4

A lithium secondary battery was prepared in the same manner as in Example 1, except that allyl cyanide represented by Formula 13 was added instead of the compound used in Example 1.

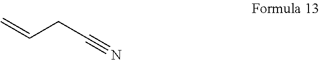

### COMPARATIVE EXAMPLE 5

A lithium secondary battery was prepared in the same manner as in Example 1, except that 2.3-dimethylfumaronitrile represented by Formula 14 was added instead of the compound used in Example 1.

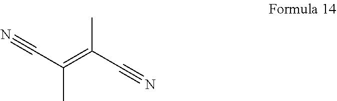

### COMPARATIVE EXAMPLE 6

A lithium secondary battery was prepared in the same manner as in Example 1, except that 3-hexenedinitrile represented by Formula 15 was added instead of the compound used in Example 1.

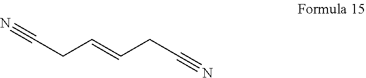

### COMPARATIVE EXAMPLE 7

A lithium secondary battery was prepared in the same manner as in Example 1, except that crotononitrile represented by Formula 16 was added instead of the compound used in Example 1.

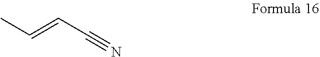

### COMPARATIVE EXAMPLE 8

A lithium secondary battery was prepared in the same manner as in Example 1, except that 2-pentenenitrile represented by Formula 17 was added instead of the compound used in Example 1.

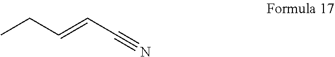

### EVALUATION EXAMPLE 1: EVALUATION OF STORAGE CHARACTERISTICS AT HIGH TEMPERATURE (90° C.)

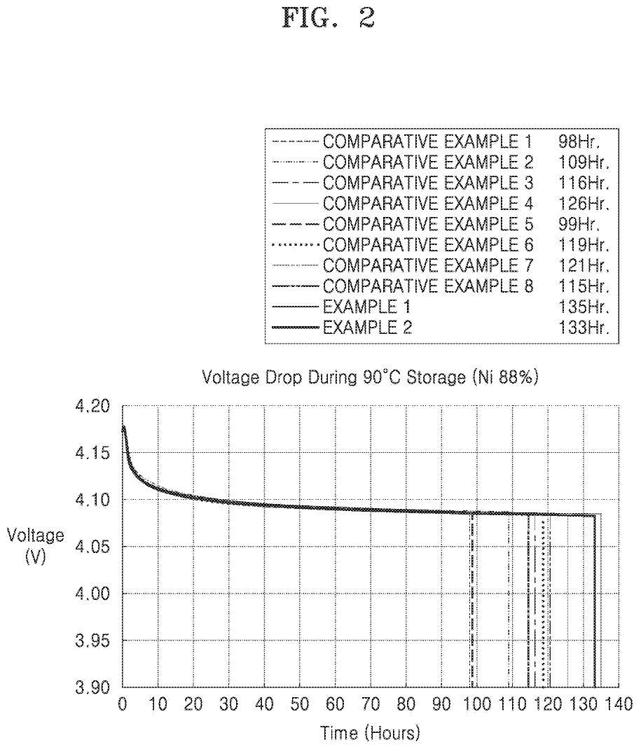

To evaluate high-temperature stability of the lithium secondary batteries prepared in Examples 1 and 2 and Comparative Examples 1 to 8, the current interrupt device (CID) open time was measured as follows, and the results are shown in FIG. 2 and Table 1 below.

First, a formation charge/discharge was performed twice at 0.2 C/0.5 C. Then, a charge/discharge experiment was performed once with a standard charge/discharge current density of 0.5 C/0.2 C, a charge end voltage of 4.2 V (Li/graphite), and a discharge end voltage of 2.6 V (Li/graphite). The lithium secondary batteries were left in a chamber at 90° C. for 140 hours to measure the CID open time.

TABLE 1

| | CID OPEN TIME (hr) |
|---|---|
| | (@ 90° C.) |
| Comparative Example 1 | 98 |
| Comparative Example 2 | 109 |
| Comparative Example 3 | 116 |
| Comparative Example 4 | 126 |
| Comparative Example 5 | 99 |
| Comparative Example 6 | 119 |
| Comparative Example 7 | 121 |
| Comparative Example 8 | 115 |
| Example 1 | 135 |
| Example 2 | 133 |

As shown in Table 1 and FIG. 2, it was confirmed that the lithium secondary batteries of Examples 1 and 2 including the compound represented by Formula 3 and the compound represented by Formula 6, respectively, had delayed CID open time compared to the lithium secondary batteries of Comparative Examples 1 to 8. That is, it was confirmed that the lithium secondary battery according to the present embodiment had a more excellent effect of suppressing gas generation when left at a high temperature.

### EXAMPLES 3 And 4

Lithium secondary battery batteries were prepared in the same manner as in Examples 1 and 2, except that, as a cathode active material, LiNi_{0.915}Co_{0.07}Al_{0.015}O₂ was used instead of LiNi_{0.88}Co_{0.105}Al_{0.015}O₂.

### COMPARATIVE EXAMPLES 9 to 16

Lithium secondary battery batteries were prepared in the same manner as in Comparative Examples 1 to 8, except that, as a cathode active material, LiNi_{0.915}Co_{0.07}Al_{0.015}O₂ was used instead of LiNi_{0.88}Co_{0.105}Al_{0.015}O₂.

### EVALUATION EXAMPLE 2: EVALUATION OF CID GAS GENERATION DURING STORAGE AT HIGH TEMPERATURE (90° C.)

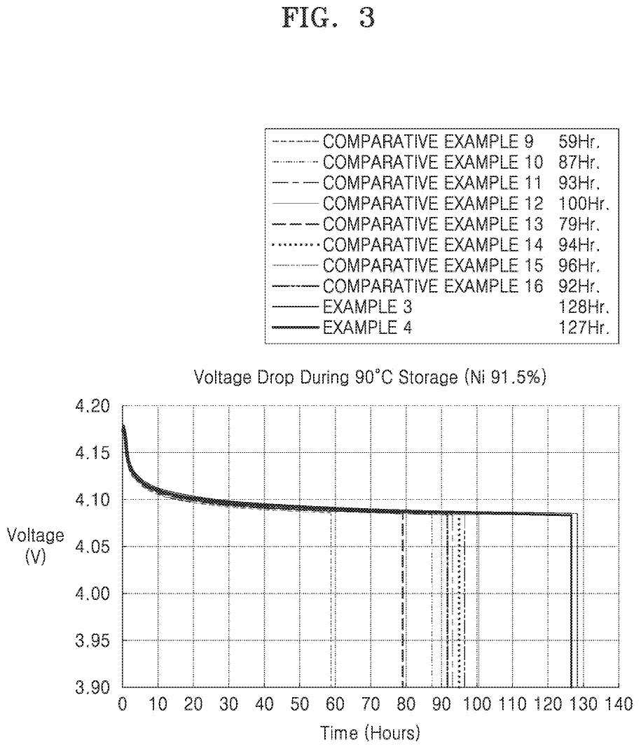

To evaluate high-temperature stability of the lithium secondary batteries prepared in Examples 3 and 4 and Comparative Examples 9 to 16, the CID open time was measured in the same manner as in Evaluation Example 1, and the results are shown in FIG. 3 and Table 2 below.

TABLE 2

| | CID OPEN TIME (hr) |
|---|---|
| | (@ 90° C.) |
| Comparative Example 9 | 59 |
| Comparative Example 10 | 87 |
| Comparative Example 11 | 93 |
| Comparative Example 12 | 100 |
| Comparative Example 13 | 79 |
| Comparative Example 14 | 94 |
| Comparative Example 15 | 96 |
| Comparative Example 16 | 92 |
| Example 3 | 128 |
| Example 4 | 127 |

As shown in Table 2 and FIG. 3, it was confirmed that the lithium secondary batteries of Examples 3 and 4 including the compound represented by Formula 3 and the compound represented by Formula 6, respectively, had delayed CID open time compared to the lithium secondary batteries of Comparative Examples 9 to 16. Furthermore, it was confirmed that the effect of improving the gas reduction of the compounds of Formulae 3 and 6 was more remarkable when the Ni amount was increased.

### EVALUATION EXAMPLE 3: EVALUATION OF INITIAL RESISTANCE

To evaluate the initial resistance of the lithium secondary batteries of Examples 1 and 2 and Comparative Examples 1 to 8, the direct current resistance (DC-IR) was measured by the following method.

Each of the lithium secondary batteries of Examples 1 and 2 and Comparative Examples 1 to 8 was charged at room temperature (25° C.) at 4 A (1.6 C) and 4.2 V, and cut-off at a current of 100 mA when a constant voltage of 4.2 V was applied, and maintained for 30 minutes. Afterwards, each of the lithium batteries was discharged under conditions of 10 A and 10 seconds, 1 A and 10 seconds, and 10 A and 4 seconds, respectively. Then, the current and voltage at 18 seconds and 23 seconds, respectively, were measured to calculate the initial resistance (i.e., a difference between the resistance at 18 seconds and the resistance at 23 seconds) according to ΔR=ΔV/ΔI.

The measured initial resistance values are shown in Table 3 below.

TABLE 3

| | Initial DC-IR (mΩ) |
|---|---|
| Comparative Example 1 | 34.5 |
| Comparative Example 2 | 35.8 |
| Comparative Example 3 | 36.6 |
| Comparative Example 4 | 38.0 |
| Comparative Example 5 | 36.9 |
| Comparative Example 6 | 36.8 |
| Comparative Example 7 | 37.0 |
| Comparative Example 8 | 36.8 |
| Example 1 | 35.0 |
| Example 2 | 35.1 |

As shown in Table 3, it was confirmed that the lithium secondary batteries of Examples 1 and 2 including the compound represented by Formula 3 and the compound represented by Formula 6, respectively, had improved initial resistance compared to the lithium secondary batteries of Comparative Examples 1 to 8.

### EXAMPLES 5 AND 6

Lithium secondary batteries were prepared in the same manner as in Examples 1 and 2, respectively, except that a 4.5 V pouch-type lithium secondary battery was used instead of the cylindrical-type lithium secondary battery.

### COMPARATIVE EXAMPLE 17

A lithium secondary battery was prepared in the same manner as in Comparative Example 1, except that a 4.5 V pouch-type lithium secondary battery was used instead of the cylindrical-type lithium secondary battery.

### EXAMPLES 7 And 8

Lithium secondary batteries were prepared in the same manner as in Examples 1 and 2, respectively, except that a 4.5 V pouch-type lithium secondary battery using LiCoO₂ as a cathode active material instead of LiNi_{0.88}Co_{0.105}Al_{0.015}O₂ and only artificial graphite as an anode active material instead of the artificial graphite and silicon composite.

### COMPARATIVE EXAMPLE 18

A lithium secondary battery was prepared in the same manner as in Comparative Example 1, except that a 4.5 V pouch-type lithium secondary battery using LiCoO₂ as a cathode active material instead of LiNi_{0.88}Co_{0.105}Al_{0.015}O₂ and only artificial graphite as an anode active material instead of the artificial graphite and silicon composite.

### EVALUATION EXAMPLE 4: EVALUATION OF GAS GENERATION DURING STORAGE AT HIGH TEMPERATURE (90° C.)

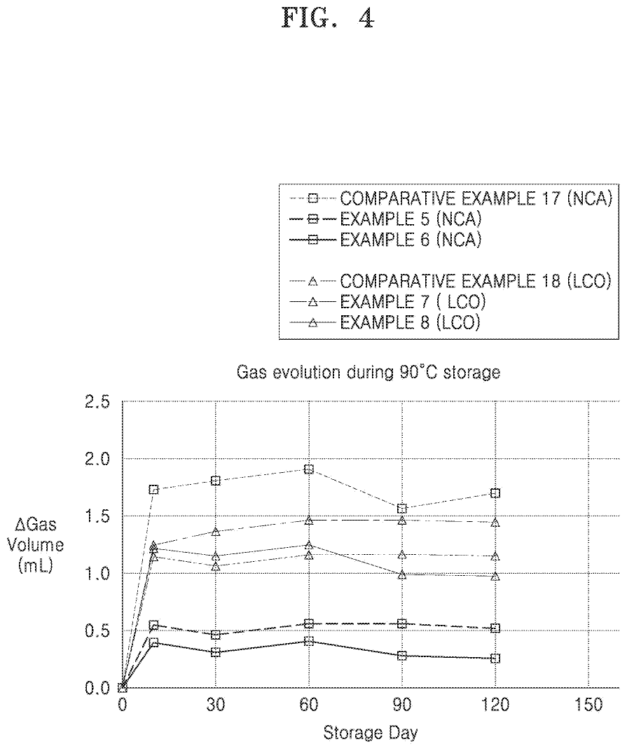

For comparison of the amount of gas generated during high-temperature storage of the lithium secondary batteries of Examples 5 and 6 and Comparative Example 17 using Ni-based cathodes and comparison of the amount of gas generated during high-temperature storage of the lithium secondary batteries of Examples 7 and 8 and Comparative Example 18 using Co-based cathodes, the evaluation was carried out as follows, and the results are shown in FIG. 4.

First, a formation charge/discharge was performed twice at 0.2 C/0.5 C. Then, a charge/discharge experiment was performed once with a standard charge/discharge current density of 0.5 C/0.2 C. a charge end voltage of 4.5 V (Li/graphite), and a discharge end voltage of 2.6 V (Li/graphite). The lithium secondary batteries were left in a chamber at 90° C. for 120 hours to measure the gas generation.

As shown in FIG. 4, in the case of Examples and Comparative Example using the Ni-based cathodes, the gas generation during high-temperature storage of the lithium secondary batteries of Examples 5 and 6 was significantly reduced compared to the lithium secondary battery of Comparative Example 17. In addition, also in the case of Examples and Comparative Example using the Co-based cathodes, the gas generation during high-temperature storage of the lithium secondary batteries of Examples 7 and 8 was significantly reduced compared to the lithium secondary battery of Comparative Example 18.

Here, during high-temperature storage, it was confirmed that the effects of gas generation reduction appeared more significantly in the Ni-based cathode than in the Co-based cathode.

Hereinabove, the embodiments have been described with reference to drawings and Examples, but these are only exemplary, and those skilled in the art can understand that various modifications and equivalent other embodiments are possible therefrom. Therefore, the scope of protection of the present invention should be defined by the appended claims.

Explanation of Reference Numerals Designating the Major
Elements of the Drawings

| | |
|---|---|
| 1: Lithium secondary battery | 2: Anode |
| 3: Cathode | 4: Separator |
| 5: Battery case | 6: Cap assembly |

### INDUSTRIAL APPLICABILITY

A lithium secondary battery including an electrolyte for a lithium secondary battery according to an embodiment may reduce gas generation even when exposed to high temperatures, and may also lower initial capacity.

1. An electrolyte for a lithium secondary battery, comprising:
a lithium salt;
an organic solvent; and
an additive,
wherein the additive comprises a compound represented by Formula 1: 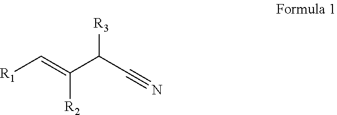
wherein, in Formula 1,
R₁ is a substituted or unsubstituted C₁-C₂₀ alkyl group, and
R₂ and R₃ are each independently selected from hydrogen, deuterium, a fluoro group (—F), a chloro group (—Cl), a bromo group (—Br), an iodo group (—I), a hydroxyl group, a cyano group, a nitro group, an amino group, an amidino group, a hydrazine group, a hydrazone group, a carboxylic acid or a salt thereof, a sulfonic acid or a salt thereof, a phosphoric acid or a salt thereof, a substituted or unsubstituted C₁-C₂₀ alkyl group, a substituted or unsubstituted C₂-C₂₀ alkenyl group, a substituted or unsubstituted C₂-C₂₀ alkynyl group, a substituted or unsubstituted C₁-C₂₀ alkoxy group, a substituted or unsubstituted C₃-C₂₀ cycloalkyl group, a substituted or unsubstituted C₂-C₂₀ heterocycloalkyl group, a substituted or unsubstituted C₃-C₂₀ cycloalkenyl group, a substituted or unsubstituted C₂-C₂₀ heterocycloalkenyl group, a substituted or unsubstituted C₆-C₂₀ aryl group, a substituted or unsubstituted C₆-C₂₀ aryloxy group, a substituted or unsubstituted C₆-C₂₀ arylthio group, a substituted or unsubstituted C₂-C₂₀ heteroaryl group, a substituted or unsubstituted monovalent non-aromatic condensed polycyclic group, a substituted or unsubstituted monovalent non-aromatic condensed heteropolycyclic group, —N(Q₁)(Q₂), and —B(Q₆)(Q₇), wherein Q₁ to Q₇ are each independently selected from hydrogen, a C₁-C₂₀ alkyl group, a C₂-C₂₀ alkenyl group, a C₂-C₂₀ alkynyl group, a C₁-C₂₀ alkoxy group, a C₃-C₂₀ cycloalkyl group, a C₂-C₂₀ heterocycloalkyl group, a C₃-C₂₀ cycloalkenyl group, a C₂-C₂₀ heterocycloalkenyl group, a C₆-C₂₀ aryl group, a C₆-C₂₀ aryloxy group, a C₆-C₂₀ arylthio group, a C₂-C₂₀ heteroaryl group, a monovalent non-aromatic condensed polycyclic group, and a monovalent non-aromatic condensed heteropolycyclic group.

2. The electrolyte of claim 1, wherein, in Formula 1, R¹ is an unsubstituted C₁-C₂₀ alkyl group, and
R² and R³ are each independently hydrogen or an unsubstituted C₁-C₂₀ alkyl group.

3. The electrolyte of claim 1, wherein, in Formula 1, R¹ is an unsubstituted linear or branched C₁-C₂₀ alkyl group.

4. The electrolyte of claim 1, wherein the additive comprises a compound represented by Formula 2: 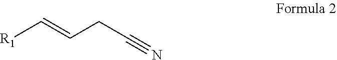
wherein, in Formula 2,
R¹ is a substituted or unsubstituted C₁-C₂₀ alkyl group.

5. The electrolyte of claim 1, wherein the additive comprises at least one of compounds represented by Formulae 3 to 6:

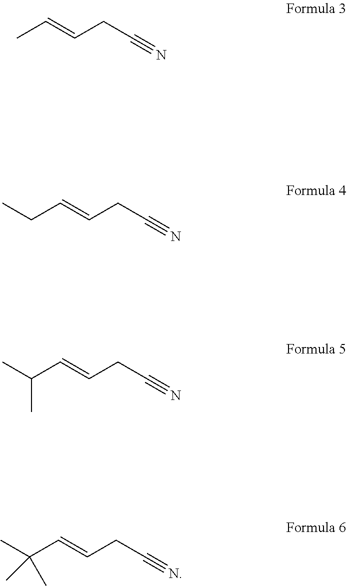

6. The electrolyte of claim 1, wherein an amount of the compound is in a range of about 0.001 parts by weight to about 20 parts by weight based on 100 parts by weight of an electrolyte solution consisting of the lithium salt and the organic solvent.

7. The electrolyte of claim 1, wherein the electrolyte further comprises other additives, and the other additives comprise at least one of vinylene carbonate (VC), fluoroethylene carbonate (FEC), difluoroethylene carbonate (DFEC), chloroethylene carbonate (CEC), dichloroethylene carbonate (DCEC), bromoethylene carbonate (BEC), dibromoethylene carbonate (DBEC), nitroethylene carbonate, cyanoethylene carbonate, vinylethylene carbonate (VEC), succinonitrile (SN), adiponitrile (AN), 1,3,6-hexane tricyanide (HTCN), prophene sultone (PST), propanesultone (PS), lithium tetrafluoroborate (LiBF₄), lithium difluorophosphate (LiPO₂F₂), and 2-fluoro biphenyl(2-FBP).

8. The electrolyte of claim 7, wherein an amount of the other additives is in a range of about 0.2 parts by weight to about 20 parts by weight based on 100 parts by weight of an electrolyte solution consisting of the lithium salt and the organic solvent.

9. A lithium secondary battery comprising:
a cathode comprising a cathode active material layer;
an anode comprising an anode active material layer; and
the electrolyte according to claim 1 disposed between the cathode and the anode.

10. The lithium secondary battery of claim 9, wherein the cathode active material comprises a lithium transition metal oxide comprising nickel and other transition metals, and an amount of the nickel in the lithium transition metal oxide is greater than or equal to about 60 mol % and less than about 100 mol % based on the total number of moles of the transition metals.

11. The lithium secondary battery of claim 9, wherein the cathode active material comprises a compound represented by Formula 11:
LiₐNiₓCo_{y}M_{z}O_{2-b}A_{b} Formula 11
wherein, in Formula 11, 1.0≤a≤1.2, 0≤b≤0.2, 0.6≤x<1, 0<y≤0.4, 0<z≤0.4, x+y+z=1, M is at least one selected from the group consisting of manganese (Mn), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), and boron (B), and A is F, S, Cl, Br, or a combination thereof.
